(19) United States
(12) Patent Application Publication
(10) Pub. No.: US 2025/0218683 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Yeong Lim Kwon, Suwon-si (KR); Won Chul Sim, Suwon-si (KR); Soo Hwan Son, Suwon-si (KR); Young Ghyu Ahn, Suwon-si (KR)

(73) Assignee: SAMSUNG ELECTRO-MECHANICS CO., LTD., Suwon-si (KR)

(21) Appl. No.: 18/989,235

(22) Filed: Dec. 20, 2024

(30) Foreign Application Priority Data
Dec. 28, 2023 (KR) 10-2023-0195367

(51) Int. Cl. H01G 4/232; H01G 4/30

(52) U.S. Cl. CPC H01G 4/2325; H01G 4/30

(57) ABSTRACT

A multilayer electronic component includes a body including a capacitance formation portion including a dielectric layer and internal electrodes disposed alternately with the dielectric layer in a first direction, and cover portions disposed on both surfaces in the first direction of the capacitance formation portion, and including first and second surfaces opposing each other in the first direction, third and fourth surfaces connected to the first and second surfaces and connected to each other in a second direction, and fifth and sixth surfaces connected to the first to fourth surfaces and opposing each other in a third direction; connection electrodes disposed on the third and fourth surfaces and connected to the internal electrode; side margin portions disposed on the fifth and sixth surfaces and including resin; and external electrodes disposed on the connection electrodes and including conductive metal and resin.

### CROSS-REFERENCE TO RELATED APPLICATION(S)

The application claims benefit of priority to Korean Patent Application No. 10-2023-0195367 filed on Dec. 28, 2023 in the Korean Intellectual Property Office, the disclosure of which is incorporated herein by reference in its entirety.

### BACKGROUND

### 1. Technical Field

The present disclosure relates to a multilayer electronic component.

### 2. Description of the Related Art

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

Such a multilayer ceramic capacitor may be used as a component of various electronic devices, since a multilayer ceramic capacitor may have a small size and high capacitance and may be easily mounted. As electronic devices such as computers and mobile devices have been designed to have a reduced size and a high output, the demand for a reduced size and high capacitance of a multilayer ceramic capacitor has also been increased.

Also, as interest in automotive electrical components has recently increased, it may be necessary for a multilayer ceramic capacitor to have high reliability and high strength properties to be used in an automobile or an infotainment system.

In the process of printing and laminating an internal electrode on a forming sheet, a slight difference in heights between a portion in which the internal electrode is not printed and a portion in which the internal electrode is printed may accumulate, such that a step difference may be formed. Particularly, in the case of a general cutting method in which a margin is present in the width direction, a step difference of the margin portion in the width direction in which the non-printed portion of the internal electrode is continuously accumulated may be more severe than a margin in the length direction in which a printed portion and a non-printed portion of the internal electrode are alternately laminated. Due to the step difference, the end portion of each sheet may be bent, such that stress may be generated, and accordingly, defects such as delamination in which the layers are separated from each other may occur.

Accordingly, to present the step difference in the width direction in the margin of the multilayer ceramic capacitor, by exposing the internal electrode in the width direction of the body, through a design without a margin in the width direction, the area in the width direction of the internal electrode may increase and the step difference may be eliminated, and one or more ceramic green sheets may be laminated in the width direction on the exposed surface in the width direction of an electrode of the chip before firing after the chip is manufactured.

However, when the side margin portion is formed of a ceramic material, cracks may easily occur such that reliability may be degraded.

### SUMMARY

An embodiment of the present disclosure is to provide a multilayer electronic component having improved reliability.

An embodiment of the present disclosure is to prevent cracks occurring in a side margin portion of a multilayer electronic component.

According to an embodiment of the present disclosure, a multilayer electronic component includes a body including a capacitance formation portion including a dielectric layer and internal electrodes disposed alternately with the dielectric layer in a first direction, and a cover portion disposed on both surfaces of the capacitance formation portion in the first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces; a connection electrode disposed on the third and fourth surfaces and connected to the internal electrodes; a side margin portion disposed on the fifth and sixth surfaces and including a first resin; and an external electrode disposed on the connection electrode and including a first conductive metal and a second resin, wherein the side margin portion is disposed to cover both ends of the connection electrode in the third direction, and wherein the external electrode covers both ends of the side margin portion in the second direction.

According to an embodiment of the present disclosure, a multilayer electronic component includes a body including a capacitance formation portion including a dielectric layer and internal electrodes disposed alternately with the dielectric layer in a first direction, and a cover portion disposed on both surfaces of the capacitance formation portion in the first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces; a connection electrode disposed on the third and fourth surfaces and connected to the internal electrodes; a side margin portion disposed on the fifth and sixth surfaces and including a first resin; and an external electrode disposed on the connection electrode and including a first conductive metal and a second resin, wherein the side margin portion is disposed to cover both ends of the connection electrode in the third direction, and wherein the side margin portion is disposed spaced apart from the third and fourth surfaces.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a perspective diagram illustrating a multilayer electronic component without an external electrode according to an embodiment of the present disclosure;

FIG. 3 is a perspective diagram illustrating a body of a multilayer electronic component according to an embodiment of the present disclosure;

FIG. 4 is a cross-sectional diagram taken along line I-I′ in FIG. 1;

FIG. 5 is a cross-sectional diagram taken along line II-II′ in FIG. 1;

FIG. 6 is a cross-sectional diagram taken along line III-III′ in FIG. 1;

FIG. 7 is a diagram illustrating a method of manufacturing a multilayer electronic component according to an embodiment of the present disclosure;

FIG. 8 is a diagram corresponding to FIG. 6 according to another embodiment of the present disclosure; and

FIG. 9 is a diagram corresponding to FIG. 6 according to another embodiment of the present disclosure.

### DETAILED DESCRIPTION

Hereinafter, embodiments of the present disclosure will be described as below with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope of the present invention are defined only by appended claims, appropriately interpreted, along with the full range of equivalents to which the claims are entitled.

In the drawings, same elements will be indicated by same reference numerals. Also, redundant descriptions and detailed descriptions of known functions and elements which may unnecessarily make the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a thickness (T) direction, the second direction may be defined as a length (L) direction, and the third direction may be defined as a width (W) direction.

### Multilayer Electronic Component

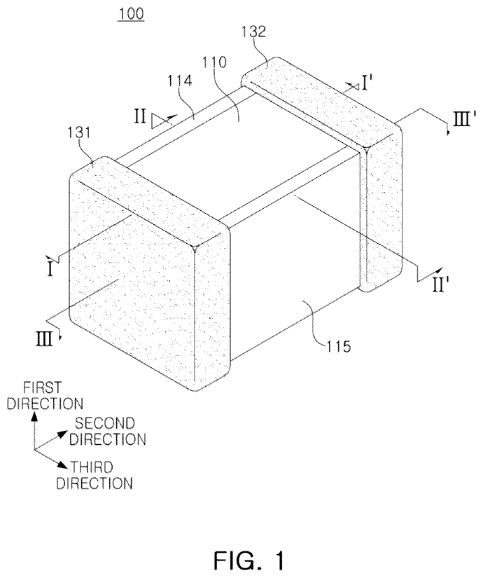

FIG. 1 is a perspective diagram illustrating a multilayer electronic component according to an embodiment.

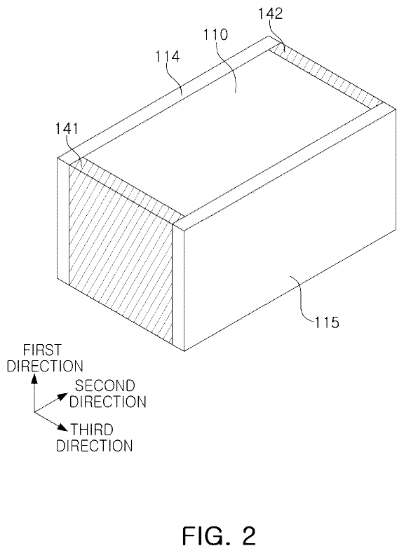

FIG. 2 is a perspective diagram illustrating a multilayer electronic component without an external electrode according to an embodiment.

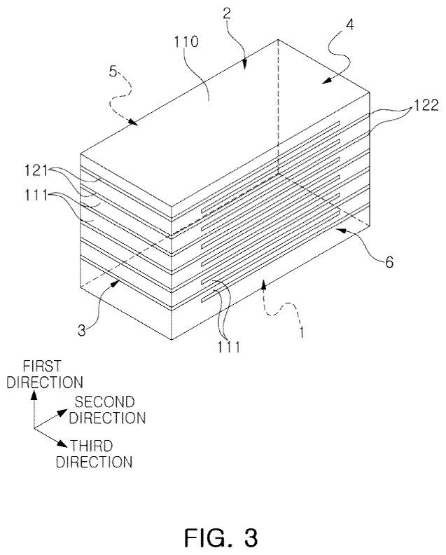

FIG. 3 is a perspective diagram illustrating a body of a multilayer electronic component according to an embodiment.

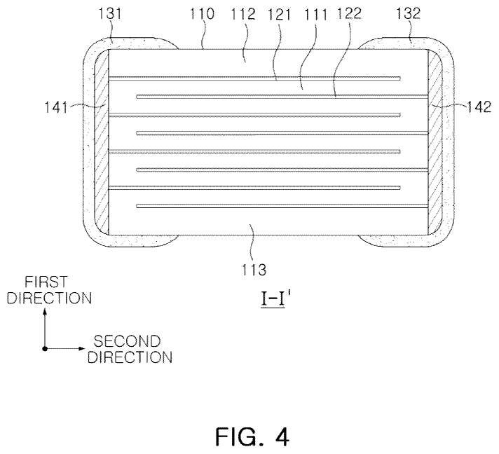

FIG. 4 is a cross-sectional diagram taken along line I-I′ in FIG. 1.

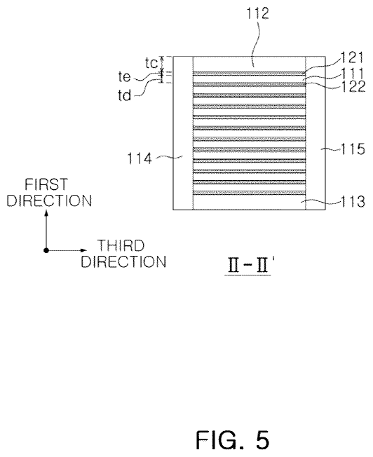

FIG. 5 is a cross-sectional diagram taken along line II-II′ in FIG. 1.

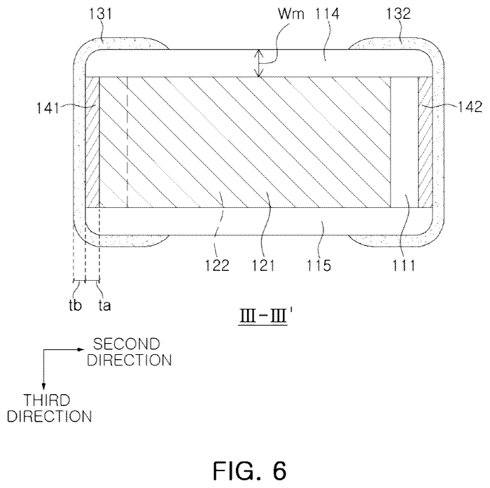

FIG. 6 is a cross-sectional diagram taken along line III-III′ in FIG. 1.

Hereinafter, a multilayer electronic component 100 according to an embodiment will be described in greater detail with reference to FIGS. 1 to 6.

The multilayer electronic component 100 may include a body including a capacitance formation portion Ac including a dielectric layer 111 and internal electrodes 121 and 122 disposed alternately with the dielectric layer in the first direction, and cover portions 112 and 113 disposed on both surfaces in the first direction of the capacitance formation portion, and including first and second surfaces 1 and 2 opposing each other in the first direction, third and fourth surfaces 3 and 4 connected to the first and second surfaces and connected to each other in a second direction, and fifth and sixth surfaces 5 and 6 connected to the first to fourth surfaces and opposing each other in a third direction; connection electrodes 141 and 142 disposed on the third and fourth surfaces and connected to the internal electrode; side margin portions 114 and 115 disposed on the fifth and sixth surfaces and including resin; and external electrodes 131 and 132 disposed on the connection electrode and containing conductive metal and resin.

In the process of printing and laminating the internal electrode on the molded sheet, a step difference may occur due to accumulation of a slight height difference between a portion in which the internal electrode is not printed and a portion in which the internal electrode is printed. Particularly, in the case of a general cutting method in which a margin in the width direction is present, the step difference in the margin portion in the width direction in which the non-printed portion of the internal electrode is continuously accumulated may be more severe than the margin in the length direction in which the printed portion and the non-printed portion of the internal electrode are laminated alternately. Due to the step difference, the end portion of each sheet may be bent, such that stress may be generated, and accordingly, defects such as delamination in which the layers are separated may occur.

Accordingly, to suppress the step difference in the margin in the width direction of the multilayer ceramic capacitor, the internal electrode may be exposed in the width direction of the body, thereby increasing the area in the width direction of the internal electrode and eliminating the step difference through a design without a margin in the width direction, and a method of laminating one or more ceramic green sheets in the width direction on the exposed surface of the exposed surface of the electrode in the width direction may be applied in the process before firing after the chip is manufactured.

However, reliability may be reduced because cracks may easily occur when the side margin portion is formed of a ceramic material.

The dielectric layer may have piezoelectricity, and may expand in the lamination direction when voltage is applied. Also, as the voltage applied to the multilayer electronic component increases, the expansion in the lamination direction may be prominent. Cracks may occur due to mechanical stress caused by the expansion of the dielectric layer, and cracks may be referred to as electrostriction cracks. When the side margin portion is formed of a ceramic material, strong stress may be applied to the side margin portion, and a starting point of electrostriction cracks may be created. Particularly, in a high-voltage multilayer ceramic capacitor requiring high-voltage reliability, a dielectric layer may have an increased thickness to assure reliability, destruction due to electrostriction cracks may occur first at a voltage lower than the expected voltage due to an increased thickness of the dielectric layer.

According to an embodiment, by disposing the side margin portions 114 and 115 including resin on the fifth and sixth surfaces of the body 110, cracks occurring in the side margin portions 114 and 115 may be prevented.

In an embodiment, the side margin portions 114 and 115 may be disposed to cover both ends of the third direction of the connection electrodes 141 and 142, and the external electrodes 131 and 132 may be disposed to cover both ends of the second direction of the side margin portions 114 and 115.

In an embodiment, the side margin portions 114″ and 115″ may be spaced apart from the third and fourth surfaces.

Hereinafter, each component included in the multilayer electronic component 100 according to an embodiment will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder included in the body 110 during a firing process or polishing of corners, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first and second surfaces 1 and 2 and the third and fourth surfaces 3 and 4 and opposing each other in the third direction.

The plurality of dielectric layers 111 forming the body 110 may be in a fired state, and boundaries between adjacent dielectric layers 111 may be integrated with each other such that boundaries therebetween may not be distinct without using a scanning electron microscope (SEM). It may not be necessary to specifically limit the number of laminates of the dielectric layer, and the number of laminates may be determined by considering the size of the multilayer electronic component. For example, the body may be formed by laminating 400 or more layers of the dielectric layer.

The dielectric layer 111 may be formed by preparing a ceramic slurry including ceramic powder, an organic solvent, an additive, and a binder, preparing a ceramic green sheet by coating the slurry on a carrier film drying the slurry, and firing the ceramic green sheet. The ceramic powder is not limited to any particular example as long as sufficient electrostatic capacitance may be obtained. For example, powder based on barium titanate (BaTiO₃) and paraelectric powders based on CaZrO₃ may be used as ceramic powder. The ceramic powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1). The paraelectric powder based on CaZrO₃ may be (Ca₁₋ₓSrₓ)(Zr_{1-y}Ti_{y})O₃ (0<x<1, 0<y<1).

Accordingly, the dielectric layer 111 may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1) and (Ca₁₋ₓSrₓ) (Zr_{1-y}Ti_{y})O₃ (0<x<1, 0<y<1).

The body 110 may include a capacitance forming portion Ac forming capacitance including the first internal electrode 121 and the second internal electrode 122 disposed in the body 110 and opposing each other with the dielectric layer 111 therebetween, and cover portions 112 and 113 formed in upper and lower portions of the capacitance forming portion Ac in the first direction.

Also, the capacitance forming portion Ac may contribute to forming the capacitance of the capacitor, and may be formed by repeatedly laminating the plurality of first and second internal electrodes 121 and 122 with the dielectric layer 111 interposed therebetween.

The internal electrodes 121 and 122 may be disposed alternately with the dielectric layer 111.

The internal electrodes 121 and 122 may include first and second internal electrodes 121 and 122. The first and second internal electrodes 121 and 122 may be disposed alternately to oppose each other with the dielectric layer 111 included in the body 110 therebetween, and may be exposed to the third and fourth surfaces 3 and 4 of the body 110, respectively.

Referring to FIG. 3, the first internal electrode 121 may be spaced apart from the fourth surface 4 and may be exposed through the third surface 3, and the second internal electrode 122 may be spaced apart from the third surface 3 and may be exposed through the fourth surface 4. Also, the first internal electrode 121 may be exposed through the third, fifth and sixth surfaces 3, 5, and 6, and the second internal electrode 122 may be exposed through the fourth, fifth and sixth surfaces 4, 5, and 6.

In this case, the first and second internal electrodes 121 and 122 may be electrically separated from each other by the dielectric layer 111 disposed therebetween.

The internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof.

The average thickness td of the dielectric layer 111 and the average thickness te of the internal electrodes 121 and 122 may not be limited to any particular example.

However, the effect of suppressing cracks in the side margin portion according to an embodiment may be more remarkable in a high-voltage multilayer ceramic capacitor, and a general average thickness td of the dielectric layer 111 of a high-voltage device may be 4 μm to 20 μm.

The average thickness te of the internal electrodes 121 and 122 may not be limited to any particular example, but may be, for example, 0.4 μm to 2 μm.

Also, the average thickness td of the dielectric layer 111 and the average thickness te of the internal electrodes 121 and 122 may be arbitrarily determined according to desired properties or purposes. For example, as for a small IT electronic component to implement miniaturization and high capacitance, the average thickness td of the dielectric layer 111 may be 0.4 μm or lower, and the average thickness te of the internal electrodes 121 and 122 may be 0.4 μm or lower.

The average thickness td of the dielectric layer 111 and the average thickness te of the internal electrodes 121 and 122 may indicate the sizes of the dielectric layer 111 and the internal electrodes 121 and 122 in the first direction, respectively. The average thickness td of the dielectric layer 111 and the average thickness te of the internal electrodes 121 and 122 may be measured by scanning the cross-sections of the body 110 in the first and second directions using a scanning electron microscope (SEM) at 10,000 magnification. More specifically, the average thickness td of the dielectric layer 111 may be measured by measuring the thickness at multiple points of the dielectric layer 111, for example, 30 points at equal distances in the second direction. Also, the average thickness te of the internal electrodes 121 and 122 may be measured by measuring the thickness at multiple points of one of the internal electrodes 121 and 122, for example, 30 points at an equal distance in the second direction. The 30 points at equal distance may be designated in the capacitance forming portion. Meanwhile, the measuring the average value may be performed on 10 dielectric layers 111 and 10 internal electrodes 121 and 122, and the average thickness td of the dielectric layer 111 and the average thickness te of the internal electrodes 121 and 122 may be further generalized.

The cover portions 112 and 113 may be disposed on both surfaces of the capacitance formation portion Ac in the first direction.

The cover portions 112 and 113 may include a first cover portion 112 disposed on the upper portion in the first direction of the capacitance formation portion Ac and a second cover portion 113 disposed on the lower portion in the first direction of the capacitance formation portion Ac. The first cover portion 112 may be referred to as the upper cover portion, and the second cover portion 113 may be referred to as the lower cover portion.

The first cover portion 112 and the second cover portion 113 may be formed by laminating a single dielectric layer or two or more dielectric layers on the upper and lower surfaces of the capacitance formation portion Ac in the thickness direction, respectively, and may prevent damages to the internal electrode due to physical or chemical stress.

The first cover portion 112 and the second cover portion 113 may not include an internal electrode and may include the same material as that of the dielectric layer 111.

That is, the upper cover portion 112 and the lower cover portion 113 may include a ceramic material, for example, a barium titanate (BaTiO3) ceramic material.

The thicknesses of the cover portions 112 and 113 may not be limited to any particular example. However, since the effect of suppressing cracks in the side margin portion according to an embodiment may be more significant in a high-voltage multilayer ceramic capacitor, the thickness tc of the cover portions 112 and 113 may be 20-200 μm.

The average thickness tc of the cover portions 112 and 113 may refer to the size in the first direction, and may be an average value of the size in the first direction of the cover portions 112 and 113 measured at five points at an equal distance from the upper portion or a lower portion of the capacitance formation portion Ac.

The side margin portions 114 and 115 may be disposed on the fifth and sixth surfaces of the body 110 and may include resin. Accordingly, cracks occurring in the side margin portions 114 and 115 may be prevented.

In an embodiment, the side margin portions 114 and 115 may be disposed to cover both surfaces in the third direction of the capacitance formation portion Ac and the cover portions 112 and 113. The side margin portions 114 and 115 may include a first side margin portion 114 disposed on one surface in the third direction of the capacitance formation portion Ac and the cover portions 112 and 113, and a second side margin portion 115 disposed on the other surface in the third direction.

The side margin portions 114 and 115 may prevent damages to the internal electrode due to physical or chemical stress. Also, since the side margin portions 114 and 115 are formed of resin, cracks occurring in the side margin portions 114 and 115 may be prevented.

A method of forming the side margin portions 114 and 115 is not limited to any particular example. For example, a body 110 may be formed by laminating ceramic green sheet and a ceramic green sheet having an internal electrode pattern printed thereon and pressing the sheets and performing a firing process, connection electrodes 141 and 142 may be formed on both surfaces of the second direction of the body 110, resin liquid or solid resin is applied to both surfaces of the third direction of the body 110, thereby forming the side margin portions 114 and 115. Thereafter, paste for an external electrode including a conductive metal and resin may be applied, thereby forming the external electrodes 131 and 132.

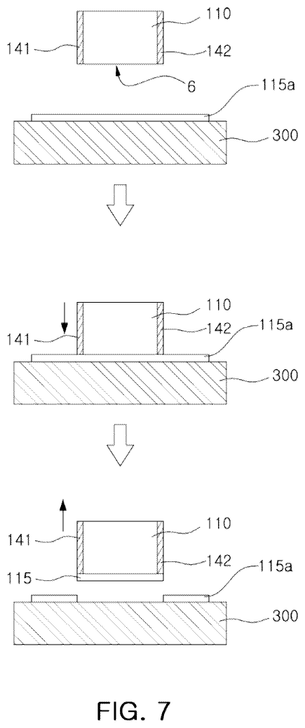

Referring to FIG. 7, an example of forming a side margin portion using solid resin will be described in greater detail. A sheet 115a formed of solid resin may be prepared on a support 300, the sixth surface 6 of the body 110 on which the connection electrodes 141 and 142 are formed may be pressed against the sheet 115a formed of solid resin such that the sheet 115a may adhere to the sixth surface 6 of the body 110, and the body 110 may be lifted again, thereby forming a second side margin portion 115 on the sixth surface 6 of the body 110. Thereafter, the same process may be performed repeatedly on the fifth surface of the body 110, thereby forming a first side margin portion 114.

According to an embodiment, since the side margin portions 114 and 115 include resin, the side margin portions 114 and 115 may be formed after performing a firing process on the body 110 and a firing process on the connection electrodes 141 and 142. Also, the external electrodes 131 and 132 may be formed by a curing heat treatment for resin without a firing process, including a conductive metal and resin.

In an embodiment, resin included in the side margin portions 114 and 115 may be one or more of an epoxy resin, a silicone resin, a fluorine resin, an acrylic resin, and ethyl cellulose.

In an embodiment, resin included in the side margin portions 114 and 115 may be the same type as resin included in the external electrode. Accordingly, the bonding strength between the external electrode 131 and 132 and the side margin portions 114 and 115 may be improved.

Also, the side margin portions 114 and 115 may be substantially formed of a resin.

In an embodiment, the side margin portions 114 and 115 may be disposed to be in contact with the internal electrodes 121 and 122 on the fifth and sixth surfaces 5 and 6.

Referring to FIG. 6, the average width Wm in the third direction of the side margin portions 114 and 115 may not be limited to any particular example. For example, Wm may be 50 μm or lower, and for miniaturization and high capacitance, Wm may be 20 μm or lower. Here, the width in the third direction of the side margin portions 114 and 115 may refer to the size in the third direction of the side margin portions 114 and 115.

The average width Wm in the third direction of the side margin portions 114 and 115 may be measured from the cross-section in the second and third direction cut from a center in the first direction of the body. The size in the third direction of the first side margin portion 114 may be measured at five points at an equal distances in the second direction, and the average value may be the average width Wm in the third direction of the first side margin portion 114.

The widths of the positions in the first direction of the side margin portions 114 and 115 may be substantially the same, and the deviation in width may be within 5%. This may be because the side margin portions 114 and 115 are formed by attaching a sheet 115a formed of solid resin to the side surface of the body 110.

The connection electrodes 141 and 142 may be disposed on the third surface 3 and the fourth surface 4 of the body 110.

The connection electrodes 141 and 142 may include a first connection electrode 141 disposed on the third surface of the body 110 and a second connection electrode 141 disposed on the fourth surface of the body 110, and the internal electrodes 121 and 122 may include a first internal electrode 121 in contact with the first connection electrode 141 and a second connection electrode 142 in contact with the second internal electrode 122, and both ends in the third direction of the first and second internal electrodes 121 and 122 may be in contact with the side margin portions 114 and 115.

The connection electrodes 141 and 142 may be formed using any material having electrical conductivity, such as a metal, and the specific material may be determined in consideration of electrical properties and structural stability.

In an embodiment, the connection electrodes 141 and 142 may include a conductive metal and glass. That is, the connection electrodes 141 and 142 may be fired electrodes including a conductive metal and glass. Accordingly, bonding strength with the body 110 may be improved, and electrical connectivity with the external electrodes 131 and 132 may be improved.

For example, the connection electrodes 141 and 142 may be formed by dipping the body in a paste including a conductive metal and glass and performing a firing process. Alternatively, the connection electrodes may be formed by pressing a sheet including a conductive metal and glass onto the body and performing a firing process.

The conductive metal included in the connection electrodes 141 and 142 may be a material having excellent electrical conductivity, and is not limited to any particular example. For example, the conductive metal may be one or more of nickel (Ni), copper (Cu), and an alloy thereof.

However, the connection electrodes 141 and 142 may not be fired electrodes, and in an embodiment, the connection electrodes 141 and 142 may be plating layers.

Also, the connection electrodes 141 and 142 may be formed by a sputtering method and an atomic layer deposition process.

Referring to FIG. 6, the average thickness ta of the connection electrodes 141 and 142 may not be limited to any particular example. For example, the average thickness ta of the connection electrodes 141 and 142 may be 5-100 μm.

The average thickness ta of the connection electrodes 141 and 142 may be measured from the cross-section in the second and third direction cut from the center in the first direction of the body. The size in the second direction of the first connection electrode 141 may be measured at five points at an equal distance in the third direction, and the average value may be the average thickness of the first connection electrode 141.

The external electrodes 131 and 132 may be disposed on the connection electrodes 141 and 142, and may include a conductive metal and resin.

The conductive metal included in the external electrodes 131 and 132 is not limited to any particular example, and may include, for example, Cu, Ni, Sn, Pd, Pt, Au, Ag, Pb, and/or alloys thereof, and more preferably, the conductive metal may include at least one of Cu, Ag, Sn, and alloys thereof.

The external electrodes 131 and 132 may absorb tensile stress generated in a mechanical or thermal environment when an electronic component is mounted on a substrate, thereby preventing cracks, and may protect the multilayer ceramic capacitor from warpage impact of the substrate.

Resin included in the external electrodes 131 and 132 may include a thermosetting resin having electrical insulation.

In this case, the thermosetting resin may be, for example, an epoxy resin, but an embodiment thereof is not limited thereto, and the thermosetting resin may be, for example, a resin having a small molecular weight and being liquid at room temperature, such as bisphenol A resin, glycol epoxy resin, novolac epoxy resin, or a derivative thereof.

Also, resin included in the external electrodes 131 and 132 may be at least one of a silicone resin, a fluorine resin, an acrylic resin, and ethyl cellulose.

The external electrodes 131 and 132 may have a multilayer structure.

For example, the external electrodes 131 and 132 may be disposed on the connection electrodes 141 and 142 and may include a conductive resin layer including a conductive metal and resin and a plating layer formed on the conductive resin layer.

The plating layer may improve mounting properties. The type of the plating layer is not limited to any particular example, and may be a plating layer including at least one of Ni, Sn, Pd, and an alloy thereof, and may be formed as a plurality of layers.

For a more specific example of the plating layer, the plating layer may be a Ni plating layer or a Sn plating layer, and the Ni plating layer and the Sn plating layer may be formed in order on the conductive resin layer, or the Sn plating layer, the Ni plating layer, and the Sn plating layer may be formed in order. Also, the plating layer may include a plurality of Ni plating layers and/or a plurality of Sn plating layers.

Referring to FIG. 6, the average thickness tb of the external electrodes 131 and 132 may not be limited to any particular example. For example, the average thickness tb of the external electrodes 131 and 132 may be 20-150 μm.

The average thickness tb of the external electrodes 131 and 132 may be measured from the cross-section in the second and third direction cut from the center in the first direction of the body. The size in the second direction of the first external electrode 131 may be measured at five points at an equal distance in the third direction, and the average value may be the average thickness of the first external electrode 131.

Referring to FIGS. 2 and 6, in an embodiment, the side margin portion may be disposed to cover both ends in the third direction of the connection electrodes 141 and 142, and the external electrode 131 and 132 may be disposed to cover both ends in the second direction of the connection electrodes 141 and 142.

In an embodiment, the external electrode 131 and 132 may be disposed to cover both ends in the second direction of the connection electrodes 141 and 142, and may extend to a portion of the side margin portions 114 and 115 on the fifth and sixth surfaces and to a portion of the first and second surfaces 1 and 2.

In an embodiment, the side margin portions 114 and 115 may be extend to a portion of the first and second surfaces 1 and 2. According to an embodiment, after forming the connection electrodes 141 and 142, the side margin portions 114 and 115 may be formed, and thereafter, the external electrode 131 and 132 may be formed, such that the external electrode 131 and 132 may be disposed on the side margin portions 114 and 115 on the first and second surfaces.

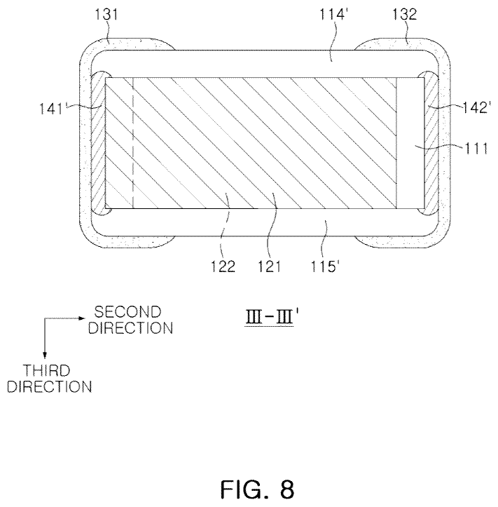

In an embodiment, referring to FIG. 8, the connection electrodes 141′ and 142′ may extend to a portion of the fifth and sixth surfaces of the body. However, the first connection electrode 141′ may extend to be spaced apart from the second internal electrode 122 exposed to the fifth and sixth surfaces of the body, and the second connection electrode 142′ may extend to be spaced apart from the first internal electrode 121 exposed to the fifth and sixth surfaces of the body.

According to an embodiment, the side margin portion 114′ and 115′ may be formed after the connection electrode 141′ and 142′ are formed, such that the side margin portion 114′ and 115′ may be disposed on the connection electrode 141′ and 142′ on the fifth and sixth surfaces.

In an embodiment, the internal electrodes 121 and 122 may include first and second internal electrodes, the first internal electrode 121 may be exposed to the third surface, may be spaced apart from the fourth surface and may be exposed to a portion of the fifth and sixth surfaces. The second internal electrode 122 may be exposed to the fourth surface, may be spaced apart from the third surface and may be exposed to a portion of the fifth and sixth surfaces. The connection electrodes 141′ and 142′ may include first and second connection electrodes, the first connection electrode 141′ may be disposed on the third surface and may extend to a portion of a region of the fifth and sixth surfaces not exposed to the second internal electrode 122, and the second connection electrode 142′ may be disposed on the fourth surface and may extend to a portion of a region not exposed to the first internal electrode 121 from the fifth and sixth surfaces.

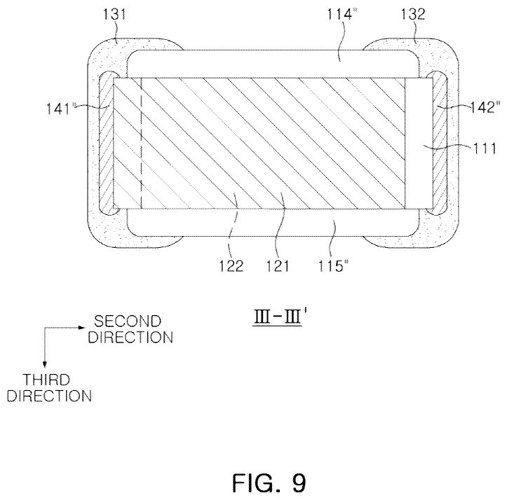

As illustrated in FIG. 9, the side margin portions 114″ and 115″ may be spaced apart from the third and fourth surfaces. However, the side margin portions 114″ and 115″ may be spaced apart from the third and fourth surfaces, and may be disposed to cover the region in which both the first and second internal electrodes are exposed among the fifth and sixth surfaces. In this case, the connection electrodes 141″ and 142″ may extend to a portion on the fifth and sixth surfaces of the body, the first connection electrode 141″ may extend to be spaced apart from the second internal electrode 122 exposed to the fifth and sixth surfaces of the body, and the second connection electrode 142″ may extend to be spaced apart from the first internal electrode 121 exposed to the fifth and sixth surfaces of the body.

Also, a portion of the external electrodes 131 and 132 may be disposed to be in contact with the fifth and sixth surfaces and may cover the third end of the side margin portions 114″ and 115″. However, the first connection electrode 141″ may extend to be spaced apart from the second internal electrode 122 exposed to the fifth and sixth surfaces of the body, and the second connection electrode 142″ may extend to be spaced apart from the first internal electrode 121 exposed to the fifth and sixth surfaces of the body.

In an embodiment, the internal electrodes 121 and 122 may include first and second internal electrodes, the first internal electrode 121 may be exposed to the third surface, may be spaced apart from the fourth surface and may be exposed to a portion of the fifth and sixth surfaces. The second internal electrode 122 may be exposed to the fourth surface, may be spaced apart from the third surface and may be exposed to a portion of the fifth and sixth surfaces. The connection electrodes 141″ and 142″ may include first and second connection electrodes, the first connection electrode 141″ may be disposed on the third surface and may be disposed in a portion of a region of the fifth and sixth surfaces not exposed to the second internal electrode 122, and the second connection electrode 142″ may be disposed on the fourth surface and may be disposed on a portion of a region of the fifth and sixth surfaces not exposed to the first internal electrode 121.

In an embodiment, the side margin portions 114″ and 115″ may be spaced apart from the first and second connection electrodes 141″ and 142″.

In an embodiment, the external electrodes 131 and 132 may be disposed to cover the space spaced apart from the side margin portions 114″ and 115″ and the first and second connection electrodes 141″ and 142″.

In an embodiment, the side margin portions 114″ and 115″ may be disposed to cover ends of the first and second connection electrodes 141″ and 142″ on the fifth and sixth surfaces.

According to the aforementioned embodiments, reliability of a multilayer electronic component may improve.

Also, by including resin in the side margin portion, cracks formed in the side margin portion may be prevented.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a capacitance formation portion including a dielectric layer and internal electrodes disposed alternately with the dielectric layer in a first direction, and a cover portion disposed on both surfaces of the capacitance formation portion in the first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces;
a connection electrode disposed on the third and fourth surfaces and connected to the internal electrodes;
a side margin portion disposed on the fifth and sixth surfaces and including a first resin; and
an external electrode disposed on the connection electrode and including a first conductive metal and a second resin,
wherein the side margin portion is disposed to cover both ends of the connection electrode in the third direction, and
wherein the external electrode covers both ends of the side margin portion in the second direction.

2. The multilayer electronic component of claim 1, wherein the connection electrode includes a second conductive metal and glass.

3. The multilayer electronic component of claim 1, wherein the connection electrode is a plating layer.

4. The multilayer electronic component of claim 1, wherein the first resin includes at least one selected from epoxy resin, silicone resin, fluorine resin, acrylic resin, and ethyl cellulose.

5. The multilayer electronic component of claim 1, wherein first resin is the same type as the second resin.

6. The multilayer electronic component of claim 1, wherein the external electrode extends to a portion of side margin portion on the fifth and sixth surfaces and to a portion of the first and second surfaces.

7. The multilayer electronic component of claim 6,
wherein the side margin portion extends to a portion of the first and second surfaces, and
wherein the external electrode is disposed on the side margin portion on the first and second surfaces.

8. The multilayer electronic component of claim 1, wherein the side margin portion is in contact with the internal electrodes on the fifth and sixth surfaces.

9. The multilayer electronic component of claim 1, wherein the side margin portion covers both surfaces of the capacitance formation portion in the third direction and the cover portion.

10. The multilayer electronic component of claim 1,
wherein the connection electrode extends to a portion of the fifth and sixth surfaces, and
wherein the side margin portion is disposed on the connection electrode on the fifth and sixth surfaces.

11. The multilayer electronic component of claim 1, wherein the first resin includes silicone resin.

12. The multilayer electronic component of claim 1, wherein the first resin includes fluorine resin.

13. The multilayer electronic component of claim 1, wherein the first resin includes acrylic resin.

14. The multilayer electronic component of claim 1, wherein the first resin includes ethyl cellulose, or
the connection electrode is disposed only on the third surface and fourth surface, or
the side margin portion consists of the first resin.

15. A multilayer electronic component, comprising:
a body including a capacitance formation portion including a dielectric layer and internal electrodes disposed alternately with the dielectric layer in a first direction, and a cover portion disposed on both surfaces of the capacitance formation portion in the first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces;
a connection electrode disposed on the third and fourth surfaces and connected to the internal electrodes;
a side margin portion disposed on the fifth and sixth surfaces and including a first resin; and
an external electrode disposed on the connection electrode and including a first conductive metal and a second resin,
wherein the side margin portion is disposed to cover both ends of the connection electrode in the third direction, and
wherein the side margin portion is disposed spaced apart from the third and fourth surfaces.

16. The multilayer electronic component of claim 15,
wherein the internal electrodes include: first and second internal electrodes,
wherein the first internal electrode extends from the third surface, spaced apart from the fourth surface, and contacts a first portion of the fifth and sixth surfaces,
wherein the second internal electrode is extends from the fourth surface, spaced apart from the third surface, and contacts a second portion of the fifth and sixth surfaces,
wherein the connection electrode includes first and second connection electrodes,
wherein the first connection electrode is disposed on the third surface and extends to a portion of a third portion of the fifth and sixth surfaces not in contact with the second internal electrode, and
wherein the second connection electrode is disposed on the fourth surface and extends to a portion of a fourth region of the fifth and sixth surfaces not in contact with the first internal electrode.

17. The multilayer electronic component of claim 16, wherein the side margin portion is spaced apart from the first and second connection electrodes.

18. The multilayer electronic component of claim 17, wherein the external electrode covers a space by which the side margin portion and the first and second connection electrodes are separated from each other.

19. The multilayer electronic component of claim 16, wherein the side margin portion covers ends of the first and second connection electrodes on the fifth and sixth surfaces.

20. The multilayer electronic component of claim 15, wherein the connection electrode includes a second conductive metal and glass.
